(19) United States
(12) Patent Application Publication
(10) Pub. No.: US 2009/0062054 A1
(43) Pub. Date: Mar. 5, 2009

(54) MULTIPLE SPEED POWER TRANSFER UNIT

(76) Inventor: Jonathan Brentnall, Ortonville, MI (US)

Correspondence Address: BUTZEL LONG;IP DOCKETING DEPT, 350 SOUTH MAIN STREET, SUITE 300, ANN ARBOR, MI, 48104, US

(21) Appl. No.: 11/911,372

(22) PCT Filed: Apr. 13, 2006
(86) PCT No.: PCT/US2006/014156

§ 371 Date: Sep. 24, 2008

Related U.S. Application Data
(60) Provisional application No. 60/670,883, filed on Apr. 13, 2005.

(51) Int. Cl. F16H 48/22; F16H 48/06

(52) U.S. Cl. 475/225; 475/323

(57) ABSTRACT

A power transfer unit for directing power to the front wheels and rear wheels of a motor vehicle includes an input, a rear drive shaft driveably connected to the rear wheels, a first gear unit having an output for producing first and second ratios of a speed of the input and a speed of the gear unit output, a differential mechanism driveably connected to the gear unit output for driving right-hand and left-hand front wheels differentially, and a second gear unit driveably connecting the rear driveshaft and the output of the first gear unit.

### BACKGROUND OF THE INVENTION

The present invention relates generally to a system for transmitting power to a pair of driving shafts (such as front halfshafts) and to a rear driveshaft of a motor vehicle. In particular, it pertains to a power transfer unit for controlling the rotational speed at which each of these shafts is driven from an input power source.

A power transfer unit usually includes a gearset for producing either a “high” range, in which the power transfer unit output is driven at the same speed as the input, or a “low” range, in which the output is driven slower than its input. A power transfer unit may operate in an all-wheel drive mode, in which power is transmitted to both front and rear driveshafts continuously. High range and low range operation of the power transfer unit is produced conventionally by alternate engagement and disengagement of range clutches.

A differential mechanism driven from an input power source permits a difference in speed between right-hand and left-hand outputs, driven from the differential input. For example, when the motor vehicle turns along a curve, a difference in rotational speed between the inner wheel and the outer wheel is permitted by the differential mechanism. A speed difference may also be caused by a difference in the magnitude of frictional force between the left and right wheels and the surface of a road.

A differential mechanism is used in a power transfer unit to permit a difference in rotational speed between front and rear driveshafts of a motor vehicle equipped with four-wheel drive or all-wheel drive. A typical structural arrangement of a differential mechanism includes a pinion located between a pair of side bevel gears coupled to output shafts. When external torque is applied to the pinion, it rotates on its own axis permitting a difference in rotational speed of the two side gears and the respective output shafts.

It is possible to enhance the turning performance or the high-speed stability of the vehicle by intentionally producing, by appropriate control, a difference in speed of rotation between the driving wheels. For example, if the left-hand wheel is driven faster than its ordinary rotational speed in a right-hand turn, then vehicle handling can be improved while turning. There is a need for a power transfer unit that can provide these and other desired improvements in vehicle handling.

The present invention provides a multiple speed input gear unit, and powershift input clutches, through which power is transmitted to the input gear unit without interrupting the flow of power from the input power source. An active differential controls the relative speeds of right side and left side drive shafts coupled to the vehicle wheels.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a top view of a motor vehicle driveline including a transmission, power transfer unit, and drive shafts extending to front wheels and rear wheels; and

FIG. 2 is a schematic diagram of a power transfer unit according to this invention for use in the driveline.

### DESCRIPTION OF THE PREFERRED EMBODIMENT

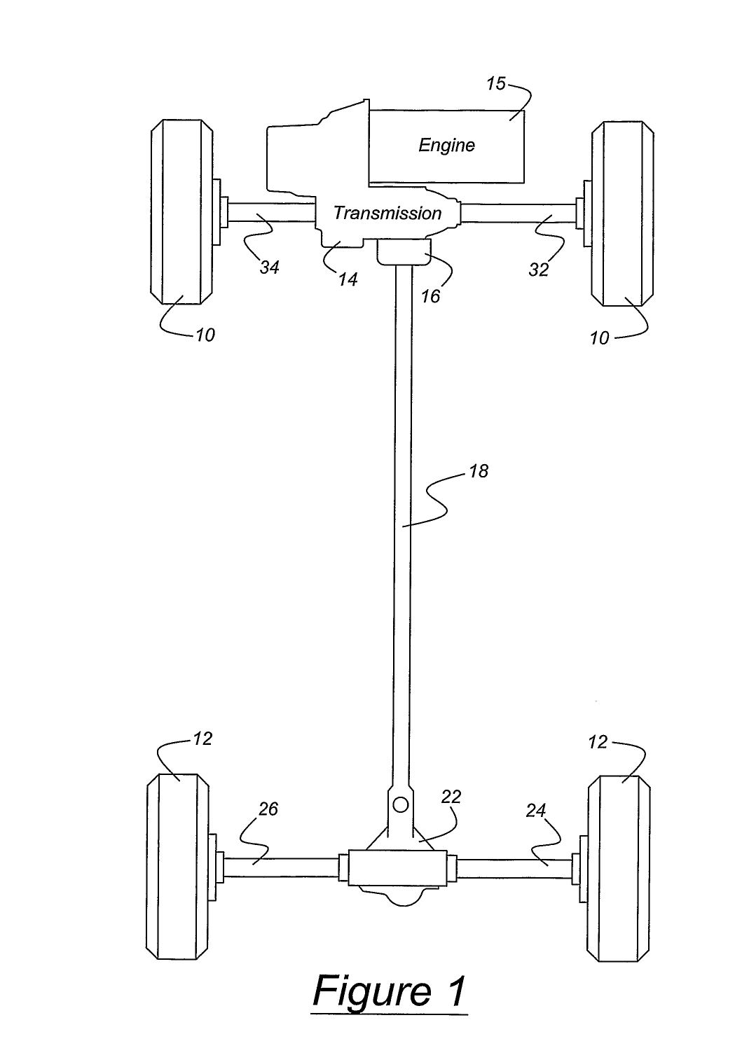

Referring now to the drawings and particularly to FIG. 1, the powertrain of a motor vehicle, to which the present invention can be applied, includes front and rear wheels 10, 12, a power transmission 14 for producing multiple forward and reverse speed ratios driven by an engine 15, and a power transfer unit 16 for continuously driveably connecting the transmission output to the front axles and rear drive shaft 18. Power is transmitted in multiple speed ratios through the power transfer unit 16 to both the front axles 32, 34, and rear drive shaft 18. Shaft 18 transmits power to a rear wheel differential mechanism 22, from which power is transmitted differentially to the rear wheels 12 through axle shafts 24, 26, which are contained within a housing. The front wheels are driveably connected to right-hand and left-hand front halfshafts 32, 34, to which power is transmitted by the power transfer unit 16 through a front differential mechanism.

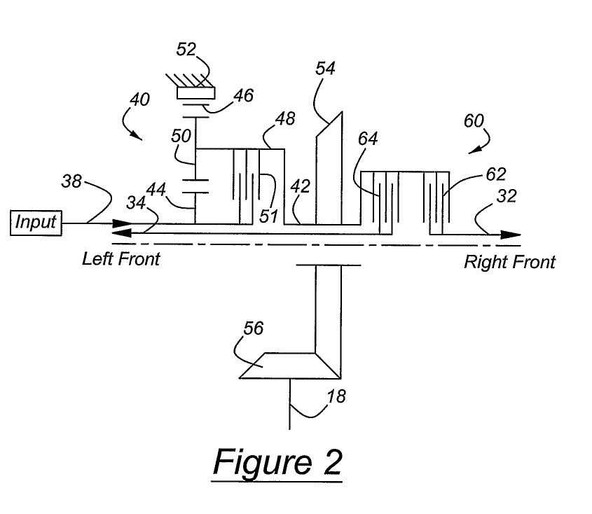

Referring now to FIG. 2, the output shaft 38 of the automatic transmission 14 is driveably connected to a first gearset, which in FIG. 2 is shown as an epicyclic gear unit 40, whose output is shaft 42 and whose input is the transmission output shaft 38. Output shaft 42 is a sleeve shaft, arranged coaxially with input shaft 38 and through which the left-hand, front halfshaft 34 extends. Gearset 40 includes a sun gear 44, secured to input 38; a ring gear 46, surrounding the sun gear; a carrier 48, which is secured to output shaft 42; and a set of planet pinions 50, rotatably supported on the carrier and in continuous meshing engagement with the sun gear and ring gear.

The epicyclic gearset further includes a friction clutch 51 and a friction brake 52. Clutch 51 is a lockup clutch, which alternately engages to produce a direct drive connection among input shaft 38, sun gear 44 and carrier 48, and disengages to allow them to rotate independently. When clutch 51 is engaged, the epicyclic gear unit 40 is locked up and output 42 is driven at the speed of input 38. When clutch 51 is disengaged and brake 52 is engaged, gear unit 40 produces a speed reduction, i.e., carrier 48 and output shaft 42 are driven at a slower speed than the speed of the input 38.

A rear drive bevel gear 54 is secured to output shaft 42 and is in continuous meshing engagement with a rear drive bevel pinion 56, which is secured to the rear drive shaft 18.

A differential mechanism 60, arranged coaxially with the halfshafts 32, 34 and driveably connected to output shaft 42, contains a right side clutch 62 secured to halfshaft 32 and a left side clutch 64 secured to halfshaft 34. The differential 60 transmits power from shaft 42 to right halfshaft 32 and left halfshaft 34 differentially, i.e., such that the shafts 32, 34 can rotate at different speeds, in accordance with the extent to which clutches 62, 64 are fully engaged, slipping or fully disengaged. In this way, the rotational speeds of the front halfshafts 32, 34 can differ mutually, and the speed of the rear driveshaft 18 is proportional to the speed of output shaft 42.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A power transfer unit for directing power to the front wheels and rear wheels of a motor vehicle comprising:
an input;
a rear drive shaft driveably connected to the rear wheels;
a first gear unit having an output, for producing first and second ratios of a speed of the input and a speed of the gear unit output;
a differential mechanism driveably connected to the gear unit output for driving right-hand and left-hand front wheels differentially; and
a second gear unit driveably connecting the rear driveshaft and the output of the first gear unit.

2. The power transfer unit of claim 1, wherein the first gear unit further comprises:
a sun gear driveably connected to the input;
a ring gear;
a carrier;
a set of planet pinions rotatably supported on the carrier in continuous meshing engagement with the sun gear and the ring gear;
a first clutch for producing a releasably drive connection between the sun gear and the carrier; and
a brake for releasably holding the ring gear against rotation.

3. The power transfer unit of claim 1, wherein the second gear unit further comprises:
a bevel pinion driveably connected to the output of the first gear unit; and
a bevel gear driveably connected to the rear drive shaft, and in meshing engagement with the bevel pinion.

4. The power transfer unit of claim 1 further comprising first and second front shafts, and wherein the differential mechanism is an active differential mechanism further comprising:
a first differential friction clutch for producing a releasable drive connection between the output of the first gear unit and the first front shaft; and
a second differential friction clutch for producing a releasable drive connection between the output of the first gear unit and the second front drive axle.
